(19) United States
(12) Patent Application Publication
(10) Pub. No.: US 2021/0285155 A1
(43) Pub. Date: Sep. 16, 2021

(54) METHODS OF MAKING SPECIALIZED CELLULOSE AND OTHER PRODUCTS FROM BIOMASS

(71) Applicant: SWEETWATER ENERGY, INC., Rochester, NY (US)

(72) Inventors: Scott TUDMAN, Honeoye Falls, NY (US); Arunas CHESONIS, Rochester, NY (US)

(21) Appl. No.: 16/760,416

(22) PCT Filed: Nov. 7, 2018
(86) PCT No.: PCT/US18/59591

§ 371 Date: Apr. 29, 2020

Related U.S. Application Data
(60) Provisional application No. 62/585,510, filed on Nov. 13, 2017.

(51) Int. Cl. D21C 1/04; D21C 1/02; D21B 1/34; C08B 15/08

(52) U.S. Cl. CPC D21C 1/04; C08B 15/08; D21B 1/34; D21C 1/02

(57) ABSTRACT

Provided is microcrystalline cellulose (MCC) from cellulosic or lignocellulosic biomass produced efficiently and quickly through cost-effective methods and systems. The MCC is comprised of short fibers due to the process through which the biomass is subjected. In addition to MCC, nanocellulose (CNF), and high quality crystalline nanocellulose (CNC) can be produced, as well as other cellulosic compounds, clean lignin and monomeric C5 and C6 sugars.

### CROSS-REFERENCE

This application is a U.S. national phase filing under 35 U.S.C. § 371 of international application No. PCT/US2018/059591, filed Nov. 7, 2018, which claims the benefit of U.S. Provisional Application No. 62/585,510, filed Nov. 13, 2017, each of which is incorporated herein by reference in its entirety.

### BACKGROUND OF THE INVENTION

Biomass is recognized as a valuable resource for natural, biodegradable polymers that can be converted into useful chemicals, fuels and other materials. Higher plant cell walls are comprised of cellulose, hemicellulose and lignin, while other organisms such as macroalgae mostly lack lignin and consist of cellulose, and/or hemicellulose and other polymers. Together, these are the most abundant renewable resources on the earth.

Polymers, however, can be difficult to separate and extract from biomass, and many different methods have been tried with just as many diverse results. Single step treatment methods, like pyrolysis, are not efficient. Although they render lower costs, severe deconstruction of the lignocellulosic biomass takes place since these methods generally rely on high temperatures and/or specialty chemicals. It is highly inconvenient and difficult to separate the targeted chemicals and fuels via single step methods because the produced bio-oil consists of a mixture of hundreds of compounds. For downstream and efficient separations, additional costs and various pretreatment methods are required. Other methods extract polymers with various solvents prior to separation of biomass components. However, these processes are expensive because the solvents must be separated and purified for reuse.

Application of most pretreatment methods can be expensive and can change the natural binding characteristics of lignocellulosic materials by modifying the supramolecular structure of cellulose-hemicellulose-lignin matrix. Another drawback of such hydrolysis and separation techniques is that the hemicellulose, cellulose, and lignin are often incompletely hydrolyzed and separated from one another, resulting in low yields. The pretreated products that ensue from such extractions are often contaminated with other inhibitory residues or each other. The enzymes for hydrolysis of polymers are expensive and inhibited by many of these byproducts of pretreatment. What is required then, are higher doses of enzymes and costly additional separation and purification techniques.

A pretreatment that provides high yields of polymers such as cellulose and lignin could be cost-effective for many bioproducts that are now produced by older, more expensive techniques. Some of the most valuable products that can be synthesized from these polymers mandate a highly purified concentration and size of a specific compound. One such product is cellulose, in the form of microcrystalline cellulose (MCC), or nanofibrillar cellulose (NFC), which is sought after for a wide range of applications in the pharmaceutical, manufacturing, packaging, transportation and other industries. Nanocellulose-based materials are carbon neutral, sustainable, recyclable and non-toxic. They thus have the potential to be truly green nanomaterials, with many useful and unexpected properties. Despite being one of the most available natural polymers on earth, it is only quite recently that cellulose has gained prominence as a nanostructured material, in the form of nanocellulose.

Another such polymer is lignin, which can account for almost 40% of plant cell walls. The amount of lignin in plant materials varies widely. In wood, it ranges from approximately 12-39% of the dry weight and it is intricately bonded with cellulose. Although lignin has been historically considered a waste material of the paper, pulp and biorefinery industries, it is a polymer comprised of valuable ring compounds. When extracted cleanly, free of inhibitors and sugars, it has many uses such as activated carbon, or as a component of foams, films, asphalt, and other compounds.

There is a need for a highly efficient biorefining process for a wide range of biomass that results in clean production and separation of biomass polymers and monomers that need little or no further refining.

### SUMMARY

In a first aspect, disclosed herein is a low-energy intensive method for producing cellulose from biomass, the method comprising: (a) pretreating said biomass with fibrillation, acid, elevated temperature and pressure through an extruder to produce a liquid fraction containing solubilized hemicellulose and/amorphous cellulose and a solids fraction consisting of cellulose and lignin; (b) separating the liquid fraction from the solids fraction; (c) treating the solids fraction to an alkaline pH to solubilize the lignin; (d) separating the solubilized lignin from the cellulose.

In some embodiments, the cellulose is crystalline and nanocellulose. In some embodiments the particle size of the cellulose is between 2 μm and 120 μm. In some embodiments, the mean particle size of the cellulose is about 60 μm. In some embodiments, the lignin is solubilized by ionic liquid. In some embodiments, the lignin is solubilized by raising the pH of the solids fraction. In some embodiments, the pH of the solids fraction is raised to a pH of about 7.5, about 8.0, about 8.5, about 9.0, about 9.5, about 10.0, about 10.5, or about 11. In some embodiments, the pH is raised by a chemical agent.

In some embodiments, a chemical agent used to raise the pH is any one or more of the compounds consisting of; sodium hydroxide, calcium hydroxide, potassium hydroxide, ammonia, ammonia hydroxide, hydrogen peroxide or a combination thereof.

In some embodiments, the lignin is solubilized by ionic liquid. In some embodiments, the ionic liquid is selected from the group consisting of; ethanol, ammonium, phosphonium and pyrrolidinium-based ionic liquids, or a combination thereof.

In some embodiments, the lignin is separated from the cellulose by centrifugation, filtration, membrane filtration, diafiltration, or flocculation. In another embodiment, the lignin is precipitated with acid. In another embodiment, the acid is selected from the group consisting of: sulfuric acid, peroxyacetic acid, hydrochloric acid, phosphoric acid, oxalic acid, lactic acid, formic acid, acetic acid, citric acid, benzoic acid, sulfurous acid, chloroacetic acid, dichloroacetic acid, trichloroacetic acid, or a combination thereof.

In some embodiments, the lignin is converted into activated carbon, foams, films or other bioproducts. In some embodiments, the liquid fraction is further fractionated with enzymes or a biocatalyst. In some embodiments, the liquid fraction is further hydrolyzed by enzymes or a biocatalyst. In some embodiments, the liquid fraction is further purified or clarified. In some embodiments, the liquid fraction is converted into a fuel. In some embodiments, the amorphous cellulose is hydrolyzed in the presence of sulfuric acid.

In some embodiments, the crystalline cellulose is MCC. In some embodiments, the crystalline cellulose is converted to nanocellulose. In some embodiments, the crystalline cellulose is a combination of MCC and nanocellulose.

In some embodiments, the crystalline cellulose or nanocellulose is decolorized with a decolorizing agent. In some embodiments, the decolorizing agent is H₂0₂.

In some embodiments, the biomass is selected from the group consisting of: corn syrup, molasses, silage, agricultural residues, corn stover, bagasse, sorghum, nuts, nut shells, coconut shells, Distillers Dried Solubles (DDS), Distillers Dried Grains (DDG), Condensed Distillers Solubles (CDS), Distillers Wet Grains (DWG), Distillers Dried Grains with Solubles (DDGS), woody materials, sawdust, wood chips, timber slash, mill scrap, municipal waste, waste paper, recycled toilet papers, yard clippings, and energy crops such as poplars, willows, switchgrass, alfalfa, and prairie bluestem, algae, including Chlorophyta, Phaeophyta, and Rhodophyta, non-woody plant matter, cellulosic material, lignocellulosic material, hemicellulosic material, carbohydrates, pectin, starch, inulin, fructans, glucans, corn, sugar cane, grasses, switchgrass, high biomass sorghum, bamboo, corncobs, peels and pits.

In some embodiments, the microcrystalline cellulose prepared from a pretreated biomass are microcrystalline cellulose particles comprising at least a mean of solid particles about 30 microns in size.

In some embodiments, a combination of MCC and nanocellulose is produced through pretreatment using acid hydrolysis in an extruder. In some embodiments, the combination of microcrystalline cellulose and nanocellulose is further refined by the steps comprising: separating the liquid fraction from the solids fraction; treating the solids fraction to an alkaline pH to solubilize the lignin; and separating the solubilized lignin from the cellulose.

In another embodiment, a cellulose product from biomass produced by a method comprising: (a) pretreating said biomass with fibrillation, acid, elevated temperature and pressure through an extruder to produce a liquid fraction containing solubilized hemicellulose and/amorphous cellulose and a solids fraction consisting of cellulose and lignin; (b) separating the liquid fraction from the solids fraction; (c) treating the solids fraction to an alkaline pH to solubilize the lignin; and (d) separating the solubilized lignin from the cellulose.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a block diagram depicting pretreatment of biomass followed by several stages of fractionation and separation to produce cellulose and sugar hydrolysate products and a lignin residue solids product.

FIG. 2 is a block diagram depicting pretreatment of biomass followed by several stages of fractionation and separation to produce microcrystalline cellulose and sugar hydrolysate products and a lignin residue solids product.

FIG. 3 is a graph depicting the xylose yields and xylose conversions following several pretreatments.

FIG. 4 is a graph depicting the control of amorphous cellulose by several pretreatments.

FIG. 5 is a graph depicting the particle size of solids following several pretreatments.

FIGS. 6A-6C are photographs showing (6A) solids fraction showing solubilized lignin and cellulose before pH adjustment, (6B) precipitated lignin under low pH conditions; and (6C) residual cellulose after lignin removal.

FIG. 7 is a photograph of the pH-adjusted cellulose after lignin removal.

FIGS. 8A-8C show (8A) peak assignments from a reference, (8B) the XDR pattern for the Avicel PH101 sample, and (8C) the XDR pattern for the experimental cellulose sample.

FIG. 9 show a particle sizing comparison of the cellulose material and a sample of Avicel PH-101 based on Horiba LA-920 analysis.

FIGS. 10A and 10B show the particle size distributions for diameter and length, respectively.

FIG. 11 is an example of the SEM (Scanning Electron Microscope) morphology of the MCC.

FIG. 12 is an AFM (Atomic Force Microscopy) image of agglomerated cellulose nanocrystals.

### DETAILED DESCRIPTION OF THE INVENTION

As used in the specification and the appended claims, the singular forms “a,” “an” and “the” include plural referents unless the context clearly dictates otherwise. Thus, for example, reference to “a purified monomer” includes mixtures of two or more purified monomers. The term “comprising” as used herein is synonymous with “including,” “containing,” or “characterized by,” and is inclusive or open-ended and does not exclude additional, unrecited elements or method steps.

“About” means a referenced numeric indication plus or minus 10% of that referenced numeric indication. For example, the term about 4 would include a range of 3.6 to 4.4. All numbers expressing quantities of ingredients, reaction conditions, and so forth used in the specification are to be understood as being modified in all instances by the term “about.” Accordingly, unless indicated to the contrary, the numerical parameters set forth herein are approximations that can vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Wherever the phrase “for example,” “such as,” “including” and the like are used herein, the phrase “and without limitation” is understood to follow unless explicitly stated otherwise. Therefore, “for example ethanol production” means “for example and without limitation ethanol production.

Cellulosic feedstocks are an economically viable source for bioproducts as they are abundant and can be converted into fuels and biochemical as the long chain polymers or hydrolyzed into oligomer or monomer sugars. Cellulose, hemicellulose and lignin are not uniformly distributed within the cell walls. The structure and the quantity of these plant cell wall components vary according to species, tissues and maturity of the plant cell wall. Generally, lignocellulosic biomass consists of 35-50% cellulose, 20-35% hemicellulose, and 10-25% lignin. Proteins, oils, and ash make up the remaining fractions.

Lignocellulosic biomass, including wood, can require high temperatures to separate the polymers contained within and, in some cases, explosion and more violent reaction with steam (explosion) and/or acid to make the biomass ready for enzyme hydrolysis. The C5 and C6 sugars are naturally embedded in and cross-linked with lignin, extractives and phenolics. The high temperature and pressures can result in the leaching of lignin and aromatics, loading with mixed sugars, high ash, lignin aromatic fragments, inhibitors, and acids in stream. Further enzymatic hydrolysis converts most of the sugars and/or sugar polymers to product valuable feedstock that can be further processed to ethanol or another alcohol, and a variety of other biochemical and bioproducts. After solubilization, the lignin can be separated from the cellulose. Separation of the lignin residues can be accomplished via flocculation, filtration, and/or centrifugation, or other methods. The extracted lignin residues can contain small amounts of ash, enzymes, sulfur, sugars, and other products.

Currently most of the global supply for fermentable refined C6 sugars is derived by processing renewable feedstocks rich in starch, such as corn, rice, cassava, wheat, sorghum and in few cases, cane sugar (comprised of glucose and fructose). Production of refined C6 sugars from these feedstocks is well established and is relatively simple because the starch is concentrated in particular plant parts (mostly seeds) and can be easily isolated and hydrolyzed to monomeric sugars using amylase enzymes. Saccharification is performed at low temperatures, resulting in fewer inhibitors and breakdown products. Starch is typically a white amorous powder and does not contain any interfering complex phenolics, acids, extractives, or colored compounds. Even if these are present, they are in such low quantity that, it is easy to refine and remove these compounds. These attributes have enabled corn refiners and starch processing companies then to provide highly-concentrated, refined sugars within tight specifications at low cost using anion exchange columns and low levels of sequestering agents. However, the remaining lignin-rich residues (lignin material) and xylose and cellulose remaining after separation of most of the sugar streams are products that, to date, have been more difficult to extract, separate and hydrolyze. They have found few economical uses, partly because of low yields and impurities. For example, lignin is burned as an energy source to produce the heat and pressure necessary to pretreat biomass, or as a feedstock for cattle and other livestock. Xylose is easy to hydrolyze but often contains inhibitors and other impurities due to the high temperatures, pressures, acid or alkali used to remove it during pretreatment. Separation of crystalline or amorphous C6 polymers from lignin is difficult and costly.

Further, all of these types of processes, whether the biomass feedstock is the whole or partial plant, or produced by an extraction process through chemical pulping process such as the black liquor from the Kraft process, or steam-explosion, high-temperature pyrolysis, Organosolv process, or another method, can result in long polymer fibers and a high ash content, and often, as in the case of pyrolysis, a condensed material. See, e.g., U.S. Publication 2015/0197424 A1. The lignin produced by these processes is not nearly as readily reactive as a lignin with a low ash and low sulfur and considerable oxygen content. The acid hydrolysis process used in this invention can be much faster and more effective than traditional pretreatment processes, and further processing steps can remove other impurities such acids, sugars and other residues, yielding a refined clean lignin and cellulose. These sugars and sugar polymers are cleaner can be used to make useful end-products such as biofuels and bioplastics. Further, the homogenous and consistently small particle size of the starting material (ensuring the carbohydrate and lignin residues have a small particle size), are derived through the removal of the amorphous cellulose and hemicellulose.

In this specification and in the claims that follow, reference will be made to a number of terms which shall be defined to have the following meanings.

Definitions

“Optional” or “optionally” means that the subsequently described event or circumstance may or may not occur, and that the description includes instances where said event or circumstance occurs and instances where it does not. For example, the phrase “the medium can optionally contain glucose” means that the medium may or may not contain glucose as an ingredient and that the description includes both media containing glucose and media not containing glucose.

Unless characterized otherwise, technical and scientific terms used herein have the same meaning as commonly understood by one of ordinary skill in the art.

“ Fermentive end-product” and “fermentation end-product” are used interchangeably herein to include biofuels, chemicals, compounds suitable as liquid fuels, gaseous fuels, triacylglycerols, reagents, chemical feedstocks, chemical additives, processing aids, food additives, bioplastics and precursors to bioplastics, and other products.

Fermentation end-products can include polyols or sugar alcohols; for example, methanol, glycol, glycerol, erythritol, threitol, arabitol, xylitol, ribitol, mannitol, sorbitol, dulcitol, fucitol, iditol, inositol, volemitol, isomalt, maltitol, lactitol, and/or polyglycitol.

The term “pH modifier” as used herein has its ordinary meaning as known to those skilled in the art and can include any material that will tend to increase, decrease or hold steady the pH of the broth or medium. A pH modifier can be an acid, a base, a buffer, or a material that reacts with other materials present to serve to raise, lower, or hold steady the pH. In one embodiment, more than one pH modifier can be used, such as more than one acid, more than one base, one or more acid with one or more bases, one or more acids with one or more buffers, one or more bases with one or more buffers, or one or more acids with one or more bases with one or more buffers. In one embodiment, a buffer can be produced in the broth or medium or separately and used as an ingredient by at least partially reacting in acid or base with a base or an acid, respectively. When more than one pH modifiers are utilized, they can be added at the same time or at different times. In one embodiment, one or more acids and one or more bases are combined, resulting in a buffer. In one embodiment, media components, such as a carbon source or a nitrogen source serve as a pH modifier; suitable media components include those with high or low pH or those with buffering capacity. Exemplary media components include acid- or base-hydrolyzed plant polysaccharides having residual acid or base, ammonia fiber explosion (AFEX) treated plant material with residual ammonia, lactic acid, corn steep solids or liquor.

The term “lignin” as used herein has its ordinary meaning as known to those skilled in the art and can comprise a cross-linked organic, racemic phenol polymer with molecular masses in excess of 10,000 Daltons that is relatively hydrophobic and aromatic in nature. Its degree of polymerization in nature is difficult to measure, since it is fragmented during extraction and the molecule consists of various types of substructures that appear to repeat in a haphazard manner. There are three monolignol monomers, methoxylated to various degrees: p-coumaryl alcohol, coniferyl alcohol, and sinapyl alcohol. These lignols are incorporated into lignin in the form of the phenylpropanoids p-hydroxyphenyl (H), guaiacyl (G), and syringyl (S), respectively. All lignins contain small amounts of incomplete or modified monolignols, and other monomers are prominent in non-woody plants. Lignins are one of the main classes of structural materials in the support tissues of vascular and nonvascular plants and some algae. Lignins are particularly important in the formation of cell walls, especially in wood and bark.

The term “pyrolysis” as used herein has its ordinary meaning as known to those skilled in the art and generally refers to thermal decomposition of a carbonaceous material. In pyrolysis, less oxygen is present than is required for complete combustion, such as less than 10%. In some embodiments, pyrolysis can be performed in the absence of oxygen.

The term “plant polysaccharide” as used herein has its ordinary meaning as known to those skilled in the art and can comprise one or more polymers of sugars and sugar derivatives as well as derivatives of sugar polymers and/or other polymeric materials that occur in plant matter. Exemplary plant polysaccharides include cellulose, starch, pectin, and hemicellulose. Others are chitin, sulfonated polysaccharides such as alginic acid, agarose, carrageenan, porphyran, furcelleran and funoran. Generally, the polysaccharide can have two or more sugar units or derivatives of sugar units. The sugar units and/or derivatives of sugar units can repeat in a regular pattern, or otherwise. The sugar units can be hexose units or pentose units, or combinations of these. The derivatives of sugar units can be sugar alcohols, sugar acids, amino sugars, etc. The polysaccharides can be linear, branched, cross-linked, or a mixture thereof. One type or class of polysaccharide can be cross-linked to another type or class of polysaccharide.

The term “saccharification” as used herein has its ordinary meaning as known to those skilled in the art and can include conversion of plant polysaccharides to lower molecular weight species that can be utilized by the organism at hand. For some organisms, this would include conversion to monosaccharides, disaccharides, trisaccharides, and oligosaccharides of up to about seven monomer units, as well as similar sized chains of sugar derivatives and combinations of sugars and sugar derivatives.

The term “biomass” as used herein has its ordinary meaning as known to those skilled in the art and can include one or more carbonaceous biological materials that can be converted into a biofuel, chemical or other product. Biomass as used herein is synonymous with the term “feedstock” and includes corn syrup, molasses, silage, agricultural residues (corn stalks, grass, straw, grain hulls, bagasse, etc.), nuts, nut shells, coconut shells, animal waste (manure from cattle, poultry, and hogs), Distillers Dried Solubles (DDS), Distillers Dried Grains (DDG), Condensed Distillers Solubles (CDS), Distillers Wet Grains (DWG), Distillers Dried Grains with Solubles (DDGS), woody materials (wood or bark, sawdust, wood chips, timber slash, and mill scrap), municipal waste (waste paper, recycled toilet papers, yard clippings, etc.), and energy crops (poplars, willows, switchgrass, alfalfa, prairie bluestem, algae, including macroalgae such as members of the Chlorophyta, Phaeophyta, Rhodophyta, etc.). One exemplary source of biomass is plant matter. Plant matter can be, for example, woody plant matter, non-woody plant matter, cellulosic material, lignocellulosic material, hemicellulosic material, carbohydrates, pectin, starch, inulin, fructans, glucans, corn, sugar cane, grasses, switchgrass, sorghum, high biomass sorghum, bamboo, algae and material derived from these. Plants can be in their natural state or genetically modified, e.g., to increase the cellulosic or hemicellulosic portion of the cell wall, or to produce additional exogenous or endogenous enzymes to increase the separation of cell wall components. Plant matter can be further described by reference to the chemical species present, such as proteins, polysaccharides and oils. Polysaccharides include polymers of various monosaccharides and derivatives of monosaccharides including glucose, fructose, lactose, galacturonic acid, rhamnose, etc. Plant matter also includes agricultural waste byproducts or side streams such as pomace, corn steep liquor, corncobs, corn fiber, corn steep solids, distillers grains, peels, pits, fermentation waste, straw, lumber, sewage, garbage and food leftovers. Peels can be citrus which include, but are not limited to, tangerine peel, grapefruit peel, orange peel, tangerine peel, lime peel and lemon peel. These materials can come from farms, forestry, industrial sources, households, etc. Another non-limiting example of biomass is animal matter, including, for example milk, bones, meat, fat, animal processing waste, and animal waste. “Feedstock” is frequently used to refer to biomass being used for a process, such as those described herein.

“Concentration” when referring to material in the broth or in solution generally refers to the amount of a material present from all sources, whether made by the organism or added to the broth or solution. Concentration can refer to soluble species or insoluble species, and is referenced to either the liquid portion of the broth or the total volume of the broth, as for “titer.” When referring to a solution, such as “concentration of the sugar in solution”, the term indicates increasing one or more components of the solution through evaporation, filtering, extraction, etc., by removal or reduction of a liquid portion.

The term “biocatalyst” as used herein has its ordinary meaning as known to those skilled in the art and can include one or more enzymes and/or microorganisms, including solutions, suspensions, and mixtures of enzymes and microorganisms. In some contexts this word will refer to the possible use of either enzymes or microorganisms to serve a particular function, in other contexts the word will refer to the combined use of the two, and in other contexts the word will refer to only one of the two. The context of the phrase will indicate the meaning intended to one of skill in the art. For example, a biocatalyst can be a fermenting microorganism.

“Pretreatment” or “pretreated” is used herein to refer to any mechanical, chemical, thermal, biochemical process or combination of these processes whether in a combined step or performed sequentially, that achieves disruption or expansion of the biomass so as to render the biomass more susceptible to attack by enzymes and/or microbes, and can include the enzymatic hydrolysis of released carbohydrate polymers or oligomers to monomers. In one embodiment, pretreatment includes removal or disruption of amorphous or crystalline cellulose so that the cellulose polymers are available for concentration and/or purification. In one embodiment, pretreatment includes removal or disruption of lignin so as to make the cellulose and hemicellulose polymers in the plant biomass more available to cellulolytic enzymes and/or microbes, for example, by treatment with acid or base. In one embodiment, pretreatment includes disruption or expansion of cellulosic and/or hemicellulosic material. In another embodiment, it can refer to starch release and/or enzymatic hydrolysis to glucose. Steam explosion, and ammonia fiber expansion (or explosion) (AFEX) are well known thermal/chemical techniques. Hydrolysis, including methods that utilize acids, bases, and/or enzymes can be used. Other thermal, chemical, biochemical, enzymatic techniques can also be used.

“Sugar compounds” or “sugar streams” is used herein to indicate mostly polysaccharide or monosaccharide sugars, dissolved, crystallized, evaporated, or partially dissolved, including but not limited to hexoses and pentoses; sugar alcohols; sugar acids; sugar amines; compounds containing two or more of these linked together directly or indirectly through covalent or ionic bonds; and mixtures thereof. Included within this description are disaccharides; trisaccharides; oligosaccharides; polysaccharides; and sugar chains, branched and/or linear, of any length. A sugar stream can consist of primarily or substantially C6 sugars, C5 sugars, or mixtures of both C6 and C5 sugars in varying ratios of said sugars. C6 sugars have a six-carbon molecular backbone and C5 sugars have a five-carbon molecular backbone.

As intended herein, a “liquid” composition may contain solids and a “solids” composition may contain liquids. A liquid composition refers to a composition in which the material is primarily liquid, and a solids composition is one in which the material is primarily solid.

The term, “nanocellulose” is broadly defined to include a range of cellulosic materials, including but not limited to microfibrillated cellulose (MFC), nanofibrillated cellulose (NFC), microcrystalline cellulose (MCC), nanocrystalline cellulose (NCC), and particulated or fibrillated dissolving pulp. Nanocellulose is nano scale by definition. Typically, nanocellulose as provided herein will include particles having at least one length dimension (e.g., diameter) on the nanometer scale.

“Nanofibrillated cellulose” or equivalently “cellulose nanofibrils” means cellulose fibers or regions that contain nanometer-sized particles or fibers (less than 100 nanometers in size in one dimension) , or both micron-sized and nanometer-sized particles or fibers. “Nanocrystalline cellulose” or equivalently “cellulose nanocrystals” means cellulose particles, regions, or crystals that contain nanometer-sized domains, or both micron-sized and nanometer-sized domains. “Micron-sized” includes from 1 μm to 100 μm and “nanometer-sized” includes from 0.01 nm to 1000 nm (1 μm). Larger domains (including long fibers) may also be present in these materials, for example, cellulose filaments (CF).

In some variations, this invention provides a composition comprising MCC which can be converted to nanocellulose, wherein the MCC or nanocellulose contains about 0.4 wt % sulfur content or less and an ash content of less than 4.0 wt%. In some embodiments, the MCC ornanocellulose contains about 0.1 wt % sulfur content or less, such as about 0.05 wt % sulfur content or less, about 0.02 wt % sulfur content or less, or essentially no sulfur content.

The nanocellulose may be in the form of cellulose nanocrystals, cellulose nanofibrils, or both cellulose nanocrystals and cellulose nanofibrils.

In some embodiments, the nanocellulose is characterized by a crystallinity of at least 80%, at least 85%, or at least 90%.

In some embodiments, the nanocellulose is characterized by an onset of thermal decomposition of about 300° F. or higher, such as about 325° F. or higher or about 350° F. or higher.

In some embodiments, the nanocellulose is characterized by a transmittance of less than about 20% at a wavelength of 400 nm. In these or other embodiments, the nanocellulose may be characterized by a transmittance of less than about 30% at a wavelength of 700 nm.

### Description

The following description and examples illustrate some exemplary embodiments of the disclosure in detail. Those of skill in the art will recognize that there are numerous variations and modifications of this disclosure that are encompassed by its scope. Accordingly, the description of a certain exemplary embodiment should not be deemed to limit the scope of the present disclosure.

Concept:

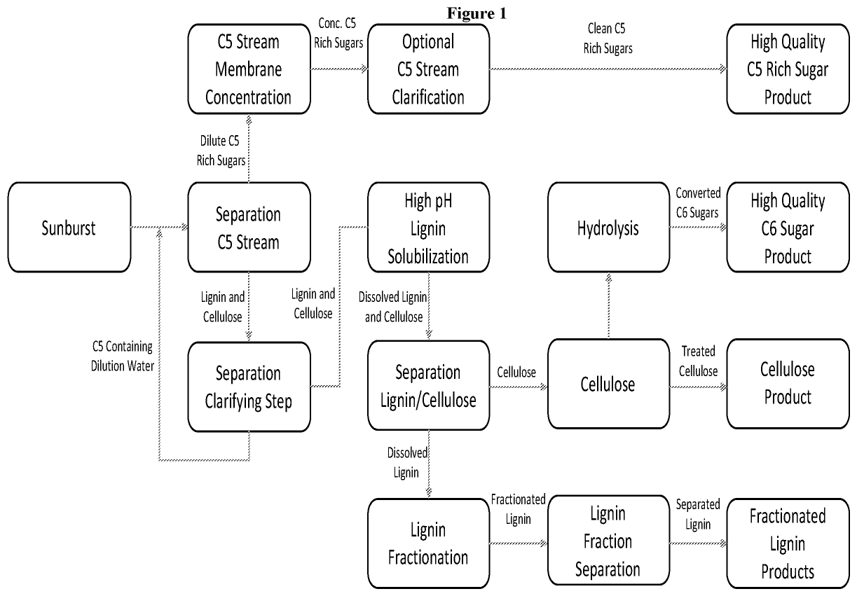

In the process system shown in FIG. 1, a biomass feedstock is pretreated through an extruder system rapidly wherein the particle size of the biomass is reduced substantially and the resulting product is subjected to uniform elevated temperature and pressure under acid conditions. See, for example, U.S. application Ser. No. 14/971,481 and U.S. application Ser. No. 15.932,340, each incorporated herein in its entirety. The C5 polymers and portions of the cellulose (C6 polymers) are hydrolyzed and separated from the pretreated stream. The pH in the resulting cellulose/lignin slurry is then elevated to solubilize the lignin which is then removed from the cellulose portion. The solubilized lignin product can be further fractionated. For example, it can be taken through a process developed by MetGen (MetGen Oy, Finland) for use in many industrial purposes. The clean cellulose is collected and used as a platform product to create a microcrystalline cellulose (MCC) product, which can be further treated to create a nanocellulose product, or to efficiently enzymatically hydrolyze it into very high quality refined C6 sugars with extremely low inhibitors and color bodies.

The object of this invention is to find an efficient and economical way to create a suite of high value products while minimizing the number of individual processing steps required. Initially, the solubilized C5 and C6 sugars are separated following pretreatment. The pH is adjusted prior to separation so that the majority of the salts are included in the C5 rich stream. It is important to minimize the carryover of soluble sugars, so a two stage separation is employed to wash out as much of the sugar as possible. The sugar from the first separation is then forwarded to a concentration step, followed by an optional clarification step. This yields a very high quality C5-rich sugar stream with low inhibitor levels that could be used for a variety of products such as xylitol formation, fuels, etc. Following the first separation, the solids are re-slurried with fresh water and a second separation step is used to wash the cellulose/lignin solids. The dilute sugar stream can be incorporated in an internal recycle scenario to dilute the pretreated material prior to the initial separation (this captures most of the sugars).

Thus, this system combines up to three separate steps that traditional methodologies need to implement: hemicellulose solubilization, fibrillation (particle downsizing), and amorphous cellulose removal (usually done with a separate acid or enzyme based process), into one simple step in this system.

The cleaned cellulose/lignin material is diluted and the pH raised to solubilize the lignin. An additional solid/liquid separation removes the particulate cellulose, and the solubilized lignin can be used to produce other products, either in a soluble form (for films, etc.) and/or further fractionated. One such process includes the MetGen enzyme-based fractionation process (a high pH solubilization is a normal part of the MetGen process). The separated cellulose is microcrystalline in nature and all or a portion of this cellulose material can then be further processed into a nanocellulose product. (MetGen OY, Kaarina, Finland).

In another embodiment, a portion of the cellulose stream is taken through a highly efficient enzymatic hydrolysis step. The advantage of the lignin removal prior to cellulose hydrolysis is a lower level of enzyme dosing, smaller tanks, with a shorter hydrolysis period required. In this example, because the majority of the inhibitors and color bodies were removed with the previous soluble C5 and lignin streams. The process ensures that the resultant C6 stream will be highly clarified and fairly free of color, so it is very desirable as a feedstock platform for a variety of high value biochemicals. The resultant sugar would be particularly suitable for conversion through biological, chemical, or catalytic pathways.

The competitive advantage of this process lies in the efficiency with which all of the end products can be extracted in high yields in a highly useful form. Methods of the prior art either separate out a smaller fraction of the C5 sugars, or the C5 sugar stream is too contaminated to use without very expensive clarification. Likewise, most biorefineries have a low lignin extraction efficiency; there is a great loss of lignin into their various streams. The process described herein maintains a very high recovery of lignin and sugars, and the addition of the fractionation technology increases the number of possible and valuable products. Most importantly, the small particle size produced in this particular pretreatment and the short, effective pretreatment period increases the lignin solubility makes it easier to get a high quality cellulose with little or no contaminants. The cellulose resulting from this extruder pretreatment is also of a smaller, uniform particle size than that resulting from other biorefinery processes and is a microcrystalline cellulose product by itself or a microcrystalline product mixed with a nanocellulose product. The high percentage recovery of C5 sugars and lignin also means that the C6 stream following hydrolysis will be extremely clean and require little or no purification.

Nanocellulose

Cellulose nanocrystals are rice-like in shape, typically 3-5 nm in width and up to 500 nm in length. CNC can have surface charge and some forms exhibit chiral nematic properties. CNC is good for strength, reinforcement, rheology modification, and also for optical, electrical, and chemical properties.

The most common process for generating nanocrystalline cellulose (NCC) is similar to that of MCC production, consisting of digestion with a strong mineral acid (such as 64% sulfuric acid, or phosphoric or hydrochloric acid), followed by mechanical size reduction (Klemm et al., 2011). Diverse parent materials can be used but wood pulp is predominant. Nanocrystalline cellulose fragments (also known as whiskers, nanowhiskers or nanocrystals) are generated with variable sizes reported in the literature (widths from 5 to 70 nm and lengths from 100 to several thousand nm). Physical properties of NCC are strongly influenced by source of parent material, the type of acid used in digest (hydrochloric or sulfuric), charge and dimensions. Several mechanical size reduction processes can be used following the acid digest such as ultrasonic treatment (Filson and Dawson-Andoh, 2009; Klemm et al., 2011), cryogenic crushing and grinding, and homogenization such as fluidization, which also increase yield. NCC may also be generated from MCC using strong mineral acid hydrolysis followed by separation by differential centrifugation, which results in a narrow size distribution of the NCC (Bai et al,, 2009). The use of strong mineral acid hydrolysis for the production of NCC either from biomass sources or from MCC encounters the same economic, environmental and safety limitations as for the production of MCC.

Newer processes to produce nanocellulose from biomass have been described by American Process Inc. and Blue Goose Biorefineries Inc. American Process uses sulfur dioxide (or sulfuric acid) and ethanol to extraction hemicellulose, lignin, and the amorphous cellulose from biomass to produce highly crystalline cellulose. The crystalline cellulose can be converted to CNF. This process requires fractionating the biomass in the presence of acid and a solvent for period of 30 minutes up to 4 hours and then further mechanical treatment to produce CNF or MCC. Then the CNF and/or MCC has to be recovered from the lignin and hemicellulose (See, U.S. Pat. No. 9,499,637 B2).

Blue Goose processes lignocellulosic biomass to first separate lignin from cellulose, then adds hydrogen peroxide and a transition metal catalyst such as Fe²⁺ in an acidic environment to separate solid cellulose from dissolved lignin and hemicellulose fractions. (See, for example, PCT/CA2012/000634).

The processes described herein do not require solvents or metal catalysts to extract cellulose from biomass. They provide a highly efficient and cost-effective pathway to easily produce high quality microcrystalline cellulose (MCC), and a subsequent low-energy pathway to create nanocellulose. Following an efficient and high-yielding pretreatment, and simple delignification step, MCC is isolated with low-cost procedure. The high value, high quality MCC provides a bio-renewable, sustainable compliment to many products.

This process, beginning with biomass utilizes every ounce of the feedstock input to create three valuable products: solubilized lignin (for concrete and asphalt applications), C5 sugars (for ethanol, or biochemical production) and MCC or nanocellulose. As a result, the cost to produce the MCC is much lower than any commercial MCC product available today, and even less expensive than low-grade commodity products, as the current competing processes are not able to retain similar value from the lignin and hemicellulose.

MCC has applications across multiple industries, including, but not limited to products in the pharmaceutical, food & beverage, cosmetics & personal care and packaging markets. The pharmaceutical application segment is the leading application in the global market. In pharmaceutical applications, MCC is one of the most important tableting excipients due to its outstanding dry binding properties, and as such is used as an ingredient in direct compression of every form of oral dosage, including pellets, capsules, tablets, sachets and other media to reduce production cost. With regard to its safety, MCC is generally regarded as safe when used in normal quantities according to the Select Committee on GRAS substances (ref. CAS Reg. No.977005-28-9, SCOGS Report No. 25, 1973).

Further, the properties and uses of nanocellulose-containing products are numerous. Nanocellulose provides high transparency, good mechanical strength, and/or enhanced gas barrier properties, and are useful as anti-wetting and/or anti-icing coatings, for example.

Some embodiments provide nanocellulose-containing products with applications for sensors, catalysts, antimicrobial materials, current carrying and energy storage capabilities. Cellulose nanocrystals have the capacity to assist in the synthesis of metallic and semiconducting nanoparticle chains.

One embodiment provides composites containing nanocellulose and a carbon-containing material, such as (but not limited to) lignin, graphite, graphene, or carbon aerogels.

Cellulose nanocrystals may be coupled with the stabilizing properties of surfactants and exploited for the fabrication of nanoarchitectures of various semiconducting materials.

The reactive surface of —OH side groups in nanocellulose facilitates grafting chemical species to achieve different surface properties. Surface functionalization allows the tailoring of particle surface chemistry to facilitate self-assembly, controlled dispersion within a wide range of matrix polymers, and control of both the particle-particle and particle-matrix bond strength. Composites may be transparent, have tensile strengths greater than cast iron, and have very low coefficient of thermal expansion. Potential applications include, but are not limited to, barrier films, antimicrobial films, transparent films, flexible displays, reinforcing fillers for polymers, biomedical implants, pharmaceuticals, drug delivery, fibers and textiles, templates for electronic components, separation membranes, batteries, supercapacitors, electroactive polymers, and many others.

Other nanocellulose applications suitable to the present invention include reinforced polymers, high-strength spun fibers and textiles, advanced composite materials, films for barrier and other properties, additives for coatings, paints, lacquers and adhesives, switchable optical devices, pharmaceuticals and drug delivery systems, bone replacement and tooth repair, improved paper, packaging and building products, additives for foods and cosmetics, catalysts, and hydrogels.

Aerospace and transportation composites may benefit from high crystallinity. Automotive applications include nanocellulose composites with polypropylene, polyamide (e.g. Nylons), or polyesters (e.g. PBT).

Nanocellulose materials provided herein are suitable as transparent and dimensionally-stable strength-enhancing additives and substrates for application in flexible displays, flexible circuits, printable electronics, and flexible solar panels. Nanocellulose is incorporated into the substrate-sheets are formed by vacuum filtration, dried under pressure and calandered, for example. In a sheet structure, nanocellulose acts as a glue between the filler aggregates. The formed calandered sheets are smooth and flexible.

Pretreatment of Biomass

In one embodiment, the feedstock (biomass) contains cellulosic, hemicellulosic, and/or lignocellulosic material. The feedstock can be derived from agricultural crops, crop residues, trees, woodchips, sawdust, paper, cardboard, grasses, algae, municipal waste and other sources.

Cellulose is a linear polymer of glucose where the glucose units are connected via β(1→4) linkages. Hemicellulose is a branched polymer of a number of sugar monomers including glucose, xylose, mannose, galactose, rhamnose and arabinose, and can have sugar acids such as mannuronic acid and galacturonic acid present as well. Lignin is a cross-linked, racemic macromolecule of mostly p-coumaryl alcohol, conferyl alcohol and sinapyl alcohol. These three polymers occur together in lignocellulosic materials in plant biomass. The different characteristics of the three polymers can make hydrolysis of the combination difficult as each polymer tends to shield the others from enzymatic attack.

In one embodiment, methods are provided for the pretreatment of feedstock for the release of sugars that can be used to further produce biofuels and biochemicals. The pretreatment steps can include mechanical, thermal, pressure, chemical, thermochemical, and/or biochemical treatment methods prior to being used in a bioprocess for the production of fuels and chemicals, but untreated biomass material can be used in the process as well. Mechanical processes can reduce the particle size of the biomass material so that it can be more conveniently handled in the bioprocess and can increase the surface area of the feedstock to facilitate contact with chemicals/biochemicals/biocatalysts. Mechanical processes can also separate one type of biomass material from another. The biomass material can also be subjected to thermal and/or chemical pretreatments to render plant polymers more accessible. Multiple steps of treatment can also be used.

Mechanical processes include, are not limited to, washing, soaking, milling, grinding, size reduction, screening, shearing, size classification and density classification processes. Chemical processes include, but are not limited to, bleaching, oxidation, reduction, acid treatment, base treatment, sulfite treatment, acid sulfite treatment, basic sulfite treatment, ammonia treatment, and hydrolysis. Thermal processes include, but are not limited to, sterilization, steam explosion, holding at elevated temperatures, pressurized or unpressurized, in the presence or absence of water, and freezing. Biochemical processes include, but are not limited to, treatment with enzymes, including enzymes produced by genetically-modified plants or organisms, and treatment with microorganisms. Various enzymes that can be utilized include cellulase, amylase, β-glucosidase, xylanase, gluconase, and other polysaccharases; lysozyme; laccase, and other lignin-modifying enzymes; lipoxygenase, peroxidase, and other oxidative enzymes; proteases; and lipases. One or more of the mechanical, chemical, thermal, thermochemical, and biochemical processes can be combined or used separately. Such combined processes can also include those used in the production of paper, cellulose products, microcrystalline cellulose, and cellulosics and can include pulping, kraft pulping, acidic sulfite processing. The feedstock can be a side stream or waste stream from a facility that utilizes one or more of these processes on a biomass material, such as cellulosic, hemicellulosic or lignocellulosic material. Examples include paper plants, cellulosics plants, distillation plants, cotton processing plants, and microcrystalline cellulose plants. The feedstock can also include cellulose-containing or cellulosic containing waste materials. The feedstock can also be biomass materials, such as wood, grasses, corn, starch, or sugar, produced or harvested as an intended feedstock for production of ethanol or other products such as by biocatalysts.

In another embodiment, a method can utilize a pretreatment process disclosed in U.S. Patents and Patent Applications US20040152881, US20040171136, US20040168960, US20080121359, US20060069244, US20060188980, US20080176301, 5693296, 6262313, US20060024801, 5969189, 6043392, US20020038058, U.S. Pat. No. 5,865,898, U.S. Pat. No. 5,865,898, U.S. Pat. Nos. 6,478,965, 5,986,133, or US20080280338, each of which is incorporated by reference herein in its entirety

In one embodiment, pretreatment of biomass comprises dilute acid hydrolysis. Example of dilute acid hydrolysis treatment are disclosed in T. A. Lloyd and C. E Wyman, Bioresource Technology, (2005) 96, 1967, incorporated by reference herein in its entirety.

In another embodiment, pretreatment of biomass comprises pH controlled liquid hot water treatment. Examples of pH controlled liquid hot water treatments are disclosed in N. Mosier et al., Bioresource Technology, (2005) 96, 1986, incorporated by reference herein in its entirety.

In one embodiment, the methods of this invention have two steps: a pretreatment step that leads to a wash stream, and a solublization/separation step of pretreated-biomass that produces a solubilized lignin stream. In this method, the pH at which the pretreatment step is carried out includes acid hydrolysis, hot water pretreatment, steam explosion. Dilute acid and hot water treatment methods solubilize mostly hemicellulose and amorphous cellulose during the pretreatment step. As a result, the wash stream from the product of pretreatment step in the contains primarily hemicellulose-based sugars, with a lesser fraction of amorphous cellulose-derived sugars. The subsequent alkaline solubilization of the residual biomass leads to a crystalline C6 solids phase (MCC) and a solubilized lignin stream. In one embodiment, the material is additionally treated to a separation step to remove the lignin and other solubilized impurities from the cellulose solids. The cellulose can be further treated to decolorize the material.

In one embodiment, solubilization step comprises ionic liquid (IL) treatment. Pretreated solids can be solubilized with an ionic liquid, followed by IL extraction with a wash solvent such as alcohol or water. The treated material can then be separated from the ionic liquid/wash-solvent solution by centrifugation or filtration, and further processed.

Production of Microcrystalline Cellulose (MCC)

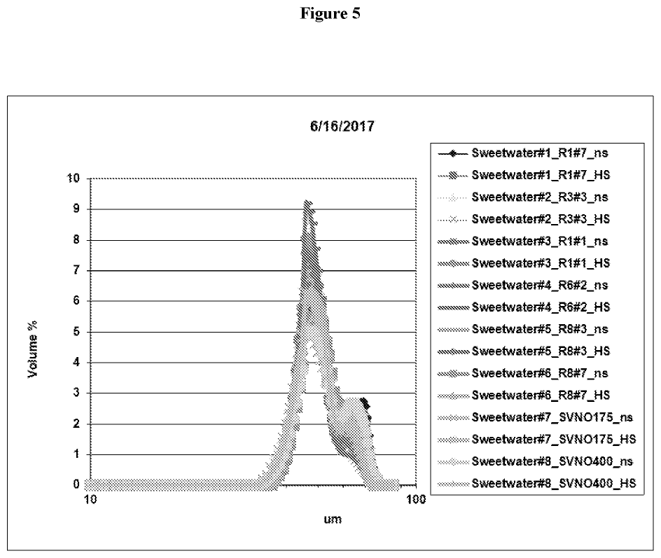

FIG. 1 depicts one pathway for the production of high value products derived from the extracted major components of biomass. The extruder rapid pretreatment system process is used to downsize biomass to a very small particle size, through a fibrillation step prior to any chemical treatment. See PCT/US2015/064850 and PCT/US2018?000047, each incorporated herein by reference in its entirety. During the chemical conversion process in this system, the biomass is further reduced in size to a mixture of particles having a uniform, or substantially uniform size ranging from 1 μm to a little over 100 μm (See FIG. 5 and Table 1). Further, the particle size of the suspended solids exiting the extruder system can be controlled.

TABLE 1
Particle size of solids from modified pretreatments.

| | Median | Mean | Size | Size |
|---|---|---|---|---|
| Filename | (um) | (um) | at 15% | at 84% |
| Sweetwater#1_R1#7_ns | 17.34 | 59.27 | 7.2092 | 137.1947 |
| Sweetwater#1_R1#7_HS | 15.46 | 51.06 | 6.8988 | 112.6866 |
| Sweetwater#2_R3#3_ns | 14.44 | 38.49 | 7.2099 | 68.8528 |
| Sweetwater#2_R3#3_HS | 11.68 | 22.16 | 6.4649 | 27.6853 |
| Sweetwater#3_R1#1_ns | 14.93 | 40.14 | 7.2461 | 76.0228 |
| Sweetwater#3_R1#1_HS | 12.67 | 28.01 | 6.7315 | 40.7820 |
| Sweetwater#4_R6#2_ns | 15.14 | 40.19 | 7.7526 | 75.1823 |
| Sweetwater#4_R6#2_HS | 11.50 | 22.29 | 6.5286 | 26.7289 |
| Sweetwater#5_R8#3_ns | 14.55 | 38.15 | 7.1089 | 67.2662 |
| Sweetwater#5_R8#3_HS | 12.91 | 26.55 | 6.6235 | 38.6792 |
| Sweetwater#6_R8#7_ns | 18.67 | 43.30 | 7.8883 | 80.8696 |
| Sweetwater#6_R8#7_HS | 15.88 | 32.63 | 7.4485 | 56.7633 |
| Sweetwater#7_SVNO175_ns | 17.14 | 51.29 | 6.2640 | 110.3149 |
| Sweetwater#7_SVNO175_HS | 13.59 | 33.34 | 5.8830 | 63.4911 |
| Sweetwater#8_SVNO400_ns | 19.15 | 52.71 | 7.2524 | 109.7136 |
| Sweetwater#8_SVNO400_HS | 14.31 | 33.29 | 6.4515 | 62.6229 |

The suspended solids are all primarily in the micron size range, and the majority of the hemicellulose and amorphous cellulose have been removed from the solid substrate, meaning that there is easy access to the lignin fraction for alkaline solubilization. Additionally, once the lignin is solubilized, a crystalline cellulose fraction remains that requires no further mechanical or enzymatic processing to yield, for example, a microcrystalline cellulose product.

Further, due to the nature of the extruder and processing structure of the zones and screws within the extruder, these particles are treated in a homogeneous manner, all being subjected to an even temperature, pressure and acid concentration. Thus few inhibitors are formed and pretreatment proceeds rapidly, within a few seconds. Additionally, the separation of biomass components is more complete with higher yields than other known methods of pretreatment.

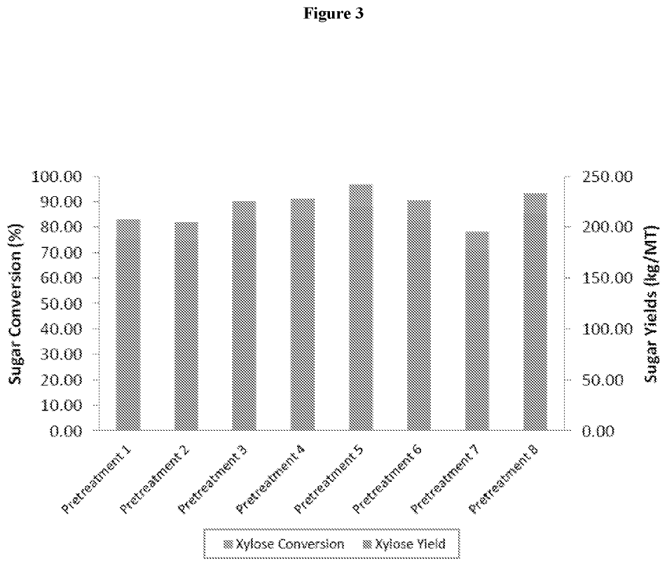

The pretreatment combines extrusion-based fibrillation of biomass fibers with rapid solubilization of the hemicellulose as well as amorphous cellulose to create a biomass slurry that is extremely well suited to further process into a microcrystalline cellulose product, C5-rich sugars and clean lignin. FIG. 3 is a graph indicating the completeness of solubilization of C5 sugars in this system. Depending on the pretreatment, over 98% of the xylose can be hydrolyzed to C5 monomers and the extruder system referenced supra allows for control over the desired percentage that is converted.

In one embodiment, the pretreated material exits the system as a slurry consisting of a liquid fraction and a solid fraction. The solids and liquids can be separated utilizing a wide variety of commercially available solid/liquid separation technologies (e.g. centrifuge, rotary press, filter press, belt filter press, decanting, flocculation etc.) yielding a liquid stream that contains soluble C5 and C6 sugar monomers and/or oligomers, acetic acid, low levels of sugar degradation products such as furfural and HMF, and salts associated with acid used in pretreatment and the base used to neutralize the slurry prior to separation. The solid fraction primarily consists of micron-sized cellulose and lignin and can proceed to the cellulose recovery step.

In one embodiment, to isolate the cellulose, the solids are reslurried and a base solution is added (e.g. sodium hydroxide, ammonium hydroxide, potassium hydroxide, lime, etc.). The lignin is very accessible after the pretreatment step and it is easily solubilized at pH above 10. After solublization, the lignin fraction is removed with an alkaline wash and a solid/liquid separation step. The soluble lignin is a clean, non-sulfonated and low ash product that is readily available to be further processed into a valuable co-product. The cellulose fraction is in a microcrystalline form that can then be refined using standard techniques into a finished product.

There are several advantages to this method over the prior art. Following the pretreatment, the solubilized hemicellulose and amorphous cellulose is removed in a liquid stream as soluble C5 and C6 sugars. There is also the added benefit of removing the majority of salts and sugar degradation by-products along with the liquid stream. The lignin fraction is not solubilized along with the hemicellulose (as carried out in the prior art), so this C5-rich stream can be readily used as a feedstock for biofuel or biochemical production without requiring a separate lignin removal step. This is very unique in the industry.

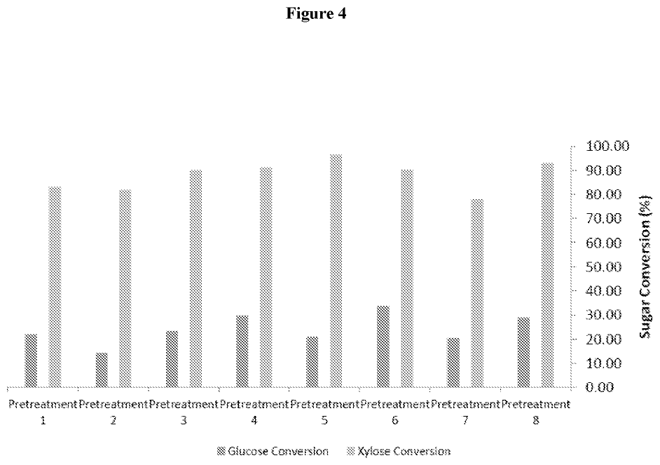

This system also provides process control over the amount of amorphous cellulose that can be removed as soluble glucose based on the adjustment of specific conditions within the pretreatment unit. See FIG. 4 wherein the control over amorphous cellulose removal is indicated by the % glucose conversion indicated in the chart for several different modified pretreatments.

After the removal of the soluble fractions, the suspended solids, consisting primarily of cellulose and a unique non-sulfonated lignin are in an optimal state for recovery. There is no need for a step to reduce the amount of sulfur in the product. The mean particle size of the suspended solids ranges from approximately 20 microns to 60 microns depending upon chosen processing conditions. This material has had the majority of the hemicellulose removed as well as a good portion of the amorphous cellulose, thus allowing for the rapid and efficient solubilization of the lignin fraction under alkaline conditions.

Most of the prior art utilizes elevated pressure and temperatures above 100 ° C. to solubilize lignin. In this invention, a wide variety of base solutions can solubilize the lignin fraction at atmospheric pressures and temperatures below 100° C. Once this liquid lignin stream is separated out, the resulting cellulose is in a microcrystalline state. The particle size is already in the micron range and the majority of the amorphous cellulose has already been solubilized and removed in the pretreatment step. Cellulose in a microcrystalline state can be used in cosmetics, pharmaceuticals, personal care, food, coatings, electronics and energy. Given the uniformity of the cellulose produced by these methods, the resulting nanocellulose can be characterized by fewer defects that normally result from intense mechanical treatment. The MCC produced in this system disperses well and remains stable.

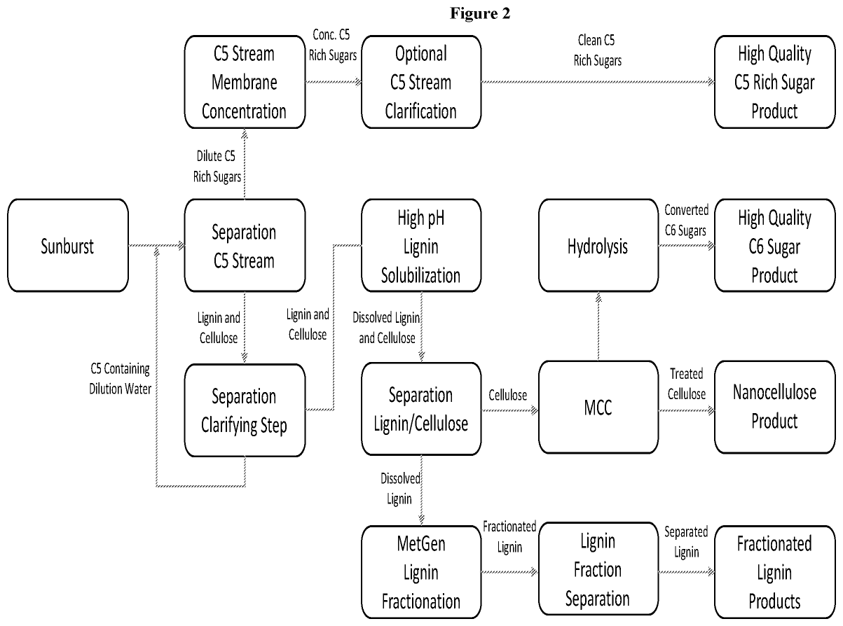

The pathway depicted in FIG. 2 leverages the strengths and capabilities of this rapid pretreatment system to convert biomass into a microcrystalline cellulose product: limiting the processing steps typically required, while maintaining high recovery of valuable coproducts: primarily monomeric xylose, glucose, and lignin. This pretreatment and cost-effective separation techniques combines extrusion-based fibrillation of biomass fibers with rapid solubilization of hemicellulose as well as amorphous cellulose to create a biomass slurry that is extremely well suited to further processing into a microcrystalline cellulose product. Once the MCC has been recovered, it can be washed and refined into varying qualities of product. The solubilized lignin has a very low sulfur content and it can be further refined into a high value co-product.

Alteration of the pH of a pretreated feedstock can be accomplished by washing the feedstock (e.g., with water) one or more times to remove an alkaline or acidic substance, or other substance used or produced during pretreatment. Washing can comprise exposing the pretreated feedstock to an equal volume of water 1, 2, 3, 4, 5, 6, 7 , 8, 9, 10, 11, 12, 13, 14, 15, 16, 17, 18, 19, 20, 21, 22, 23, 24, 25 or more times. In another embodiment, a pH modifier can be added. For example, an acid, a buffer, or a material that reacts with other materials present can be added to modulate the pH of the feedstock. In one embodiment, more than one pH modifier can be used, such as one or more bases, one or more bases with one or more buffers, one or more acids, one or more acids with one or more buffers, or one or more buffers. When more than one pH modifiers are utilized, they can be added at the same time or at different times. Other non-limiting exemplary methods for neutralizing feedstocks treated with alkaline substances have been described, for example in U.S. Pat. Nos. 4,048,341; 4,182,780; and 5,693,296.

In one embodiment, one or more acids can be combined, resulting in a buffer. Suitable acids and buffers that can be used as pH modifiers include any liquid or gaseous acid that is compatible with the microorganism. Non-limiting examples include peroxyacetic acid, sulfuric acid, lactic acid, citric acid, phosphoric acid, and hydrochloric acid. In some instances, the pH can be lowered to neutral pH or acidic pH, for example a pH of 7.0, 6.5, 6.0, 5.5, 5.0, 4.5, 4.0, 3.0, 2.0, 2.5, 1.0 or lower. In some embodiments, the pH is lowered and/or maintained within a range of about pH 4.5 to about 7.1, or about 4.5 to about 6.9, or about pH 5.0 to about 6.3, or about pH 5.5 to about 6.3, or about pH 6.0 to about 6.5, or about pH 5.5 to about 6.9 or about pH 6.2 to about 6.7.

In another embodiment, biomass can be pretreated at an elevated temperature and/or pressure. In one embodiment biomass is pretreated at a temperature range of 20° C. to 400° C. In another embodiment biomass is pretreated at a temperature of about 20° C., 25° C., 30° C., 35° C., 40° C., 45° C., 50° C., 55° C., 60° C., 65° C., 80° C., 90° C., 100° C., 120° C., 150° C., 200° C., 250° C., 300° C., 350° C., 400° C. or higher. In another embodiment, elevated temperatures are provided by the use of steam, hot water, or hot gases. In one embodiment steam can be injected into a biomass containing vessel. In another embodiment the steam, hot water, or hot gas can be injected into a vessel jacket such that it heats, but does not directly contact the biomass.

In another embodiment, a biomass can be treated at an elevated pressure. In one embodiment biomass is pretreated at a pressure range of about 1 psi to about 30 psi. In another embodiment biomass is pretreated at a pressure or about 50 psi, 100 psi, 150 psi, 200 psi, 250 psi, 300 psi, 350 psi, 400 psi, 450 psi, 500 psi, 550 psi, 600 psi, 650 psi, 700 psi, 750 psi, 800 psi or more up to 900 psi. In some embodiments, biomass can be treated with elevated pressures by the injection of steam into a biomass containing vessel. In one embodiment, the biomass can be treated to vacuum conditions prior or subsequent to alkaline or acid treatment or any other treatment methods provided herein.

In one embodiment acid pretreated biomass is washed (e.g. with water (hot or cold) or other solvent such as alcohol (e.g. ethanol)), pH neutralized with a base, or buffering agent (e.g. phosphate, citrate, borate, or carbonate salt) or dried prior to fermentation. In one embodiment, the drying step can be performed under vacuum to increase the rate of evaporation of water or other solvents. Alternatively, or additionally, the drying step can be performed at elevated temperatures such as about 20° C., 25° C., 30° C., 35° C., 40° C., 45° C., 50° C., 55° C., 60° C., 65° C., 80° C., 90° C., 100° C., 120° C., 150° C., 200° C., 250° C., 300° C. or more.

In one embodiment of the present invention, a pretreatment step includes a step of solids recovery. The solids recovery step can be during or after pretreatment (e.g., acid pretreatment), or before the drying step. In one embodiment, the solids recovery step provided by the methods of the present invention includes the use of flocculation, centrifugation, a sieve, filter, screen, or a membrane for separating the liquid and solids fractions. In one embodiment a suitable sieve pore diameter size ranges from about 0.001 microns to 8mm, such as about 0.005microns to 3mm or about 0.01 microns to 1mm. In one embodiment a sieve pore size has a pore diameter of about 0.01microns, 0.02 microns, 0.05 microns, 0.1 microns, 0.5 microns, 1 micron, 2 microns, 4 microns, 5 microns, 10 microns, 20 microns, 25 microns, 50 microns, 75 microns, 100 microns, 125 microns, 150 microns, 200 microns, 250 microns, 300 microns, 400 microns, 500 microns, 750 microns, 1mm or more. In one embodiment, biomass is processed or pretreated prior to lignin separation from cellulose. In one embodiment a method of pre-treatment includes but is not limited to, biomass particle size reduction, such as for example shredding, milling, chipping, crushing, grinding, or pulverizing. In one embodiment, biomass particle size reduction can include size separation methods such as sieving, or other suitable methods known in the art to separate materials based on size. In one embodiment size separation can provide for enhanced yields. In one embodiment, separation of finely shredded biomass (e.g. particles smaller than about 8 mm in diameter, such as, 8, 7.9, 7.7, 7.5, 7.3, 7, 6.9, 6.7, 6.5, 6.3, 6, 5.9, 5.7, 5.5, 5.3, 5, 4.9, 4.7, 4.5, 4.3, 4, 3.9, 3.7, 3.5, 3.3, 3, 2.9, 2.7, 2.5, 2.3, 2, 1.9, 1.7, 1.5, 1.3, 1, 0.9, 0.8, 0.7, 0.6, 0.5, 0.4, 0.3, 0.2, or 0.1 mm) from larger particles allows the recycling of the larger particles back into the size reduction process, thereby increasing the final yield of processed biomass.

Hydrolysis

In one embodiment, the biomass hydrolyzing unit provides useful advantages for the conversion of pretreated C5 and/or amorphous cellulose-derived C6 to biofuels and biochemical products. One advantage of this unit is its ability to produce monomeric sugars, or monomeric and oligomeric sugars from multiple types of biomass, including mixtures of different biomass materials, and is capable of hydrolyzing polysaccharides and higher molecular weight saccharides to lower molecular weight saccharides. In one embodiment, the hydrolyzing unit utilizes a pretreatment process and a hydrolytic enzyme which facilitates the production of a sugar stream containing a concentration of a monomeric or monomeric and oligomeric sugars or several monomeric sugars, or monomeric and oligomeric sugars derived from cellulosic and/or hemicellulosic polymers. Examples of biomass material that can be pretreated and hydrolyzed to manufacture sugar monomers or monomers and oligomers include, but are not limited to, cellulosic, hemicellulosic, lignocellulosic materials; pectins; starches; wood; paper; agricultural products; forest waste; tree waste; tree bark; sawdust, wood chips, leaves; grasses; sawgrass; woody plant matter; non-woody plant matter; carbohydrates; starch; inulin; fructans; glucans; corn; corcobs, corn fiber, sugar cane; sorghum, other grasses; bamboo, algae, and material derived from these materials. This ability to use a very wide range of pretreatment methods and hydrolytic enzymes gives distinct advantages in biomass fermentations. Various pretreatment conditions and enzyme hydrolysis can enhance the extraction of sugars from biomass, resulting in higher yields, higher productivity, greater product selectivity, and/or greater conversion efficiency of the saccharides during fermentation and resulting in a more pure lignin residue.

In one embodiment, the enzyme treatment is used to hydrolyze various higher saccharides (higher molecular weight) present in biomass to lower saccharides (lower molecular weight), such as in preparation for fermentation by biocatalysts such as yeasts to produce ethanol, hydrogen, or other chemicals such as organic acids including succinic acid, formic acid, acetic acid, and lactic acid. These enzymes and/or the hydrolysate can be used in fermentations to produce various products including fuels, and other chemicals.

In one example, the process for converting biomass material into ethanol includes pretreating the biomass material (e.g., “feedstock”), hydrolyzing the pretreated C5 and/or amorphous C6 sugars to convert polysaccharides to oligosaccharides, further hydrolyzing the oligosaccharides to monosaccharides, and converting the monosaccharides to biofuels and chemical products. Enzymes such as cellulases, polysaccharases, lipases, proteases, ligninases, and hemicellulases, help produce the monosaccharides can be used in the biosynthesis of fermentation end-products. Biomass material that can be utilized includes woody plant matter, non-woody plant matter, sawdust, wood chips, cellulosic material, lignocellulosic material, hemicellulosic material, carbohydrates, pectin, starch, inulin, fructans, glucans, corn, corn fiber, algae, sugarcane, other grasses, switchgrass, bagasse, wheat straw, barley straw, rice straw, corncobs, bamboo, citrus peels, sorghum, high biomass sorghum, seed hulls, nuts, nut shells, and material derived from these. The final product can then be separated and/or purified, as indicated by the properties for the desired final product. In some instances, compounds related to sugars such as sugar alcohols or sugar acids can be utilized as well.

Chemicals used in the methods of the present invention are readily available and can be purchased from a commercial supplier, such as Sigma-Aldrich. Additionally, commercial enzyme cocktails (e.g. Accellerase™ 1000, CelluSeb-TL, CelluSeb-TS, Cellic™ CTec, STARGEN™, Maxalig™, Spezyme.R™, Distillase.R™, G-Zyme.R™, Fermenzyme.R™, Fermgen™, GC 212, or Optimash™) or any other commercial enzyme cocktail can be purchased from vendors such as Specialty Enzymes & Biochemicals Co., Genencor, Novozymes, or MetGen. Alternatively, enzyme cocktails can be prepared by growing one or more organisms such as for example a fungi (e.g. a Trichoderma, a Saccharomyces, a Pichia, a White Rot Fungus etc.), a bacteria (e.g. a Clostridium, or a coliform bacterium, a Zymomonas bacterium, Sacharophagus degradans etc.) in a suitable medium and harvesting enzymes produced therefrom. In some embodiments, the harvesting can include one or more steps of purification of enzymes.

In one embodiment, treatment of pretreated C5 and/or C6 biomass comprises enzyme hydrolysis. In one embodiment a biomass is treated with an enzyme or a mixture of enzymes, e.g., endonucleases, exonucleases, cellobiohydrolases, cellulase, beta-glucosidases, glycoside hydrolases, glycosyltransferases, lyases, esterases and proteins containing carbohydrate-binding modules. In one embodiment, the enzyme or mixture of enzymes is one or more individual enzymes with distinct activities. In another embodiment, the enzyme or mixture of enzymes can be enzyme domains with a particular catalytic activity. For example, an enzyme with multiple activities can have multiple enzyme domains, including for example glycoside hydrolases, glycosyltransferases, lyases and/or esterases catalytic domains.

In one embodiment, enzymes that degrade polysaccharides are used for the hydrolysis of pretreated C5 and/or C6 polymers and can include enzymes that degrade cellulose, namely, cellulases. Examples of some cellulases include endocellulases and exo-cellulases that hydrolyze beta-1,4-glucosidic bonds.

In one embodiment, enzymes that degrade polysaccharides are used for the hydrolysis of biomass and can include enzymes that have the ability to degrade hemicellulose, namely, hemicellulases. Hemicellulose can be a major component of plant biomass and can contain a mixture of pentoses and hexoses, for example, D-xylopyranose, L-arabinofuranose, D-mannopyranose, Dglucopyranose, D-galactopyranose, D-glucopyranosyluronic acid and other sugars. In one embodiment, enzymes that degrade polysaccharides are used for the hydrolysis of biomass and can include enzymes that have the ability to degrade pectin, namely, pectinases. In plant cell walls, the cross-linked cellulose network can be embedded in a matrix of pectins that can be covalently cross-linked to xyloglucans and certain structural proteins. Pectin can comprise homogalacturonan (HG) or rhamnogalacturonan (RH).

In one embodiment, hydrolysis of biomass includes enzymes that can hydrolyze starch. Enzymes that hydrolyze starch include alpha-amylase, glucoamylase, beta-amylase, exo-alpha-1,4-glucanase, and pullulanase.

In one embodiment, hydrolysis of biomass comprises hydrolases that can include enzymes that hydrolyze chitin. In another embodiment, hydrolases can include enzymes that hydrolyze lichen, namely, lichenase.

In one embodiment, after pretreatment and/or hydrolysis by any of the above methods the feedstock contains cellulose, hemicellulose, soluble oligomers, monomeric sugars, simple sugars, lignin, volatiles and ash. The parameters of the hydrolysis can be changed to vary the concentration of the components of the pretreated feedstock. For example, in one embodiment a hydrolysis is chosen so that the concentration of soluble C5 saccharides is low and the concentration of lignin and cellulose is high after pretreatment. Examples of parameters of the pretreatment include temperature, pressure, time, concentration, composition and pH.

In one embodiment, the parameters of the pretreatment and hydrolysis are changed to vary the concentration of the components of the pretreated feedstock such that concentration of the components in the pretreated and hydrolyzed feedstock is optimal for recovery of cellulose.

In one embodiment, the parameters of the pretreatment are changed such that concentration of accessible cellulose in the pretreated feedstock is 1%, 5%, 10%, 12%, 13%, 14%, 15%, 16%, 17%, 19%, 20%, 30%, 40% or 50%. In one embodiment, the parameters of the pretreatment are changed such that concentration of accessible cellulose in the pretreated feedstock is 25% to 35%. In one embodiment, the parameters of the pretreatment are changed such that concentration of accessible cellulose in the pretreated feedstock is 10% to 20%.

In one embodiment, the parameters of the pretreatment are changed such that concentration of hemicellulose in the pretreated feedstock is 1%, 5%, or 10%. In one embodiment, the parameters of the pretreatment are changed such that concentration of hemicellulose in the pretreated feedstock is 1% to 10%. In one embodiment, the parameters of the pretreatment are changed such that concentration of hemicellulose in the pretreated feedstock is 1% to 8%.

In one embodiment, the parameters of the pretreatment are changed such that concentration of soluble oligomers in the pretreated feedstock is 1%, 10%, 15%, 20%, 25%, 30%, 35%, 40%, 45%, 50%, 55%, 60%, 65%, 70%, 75%, 80%, 85%, 90%, 95%, or 99%. Examples of soluble oligomers include, but are not limited to, cellobiose and xylobiose. In one embodiment, the parameters of the pretreatment are changed such that concentration of soluble oligomers in the pretreated feedstock is 30% to 90%. In one embodiment, the parameters of the pretreatment are changed such that concentration of soluble oligomers in the pretreated feedstock is 45% to 80%. In one embodiment, the parameters of the pretreatment and/or hydrolysis are changes such that most of the hemicellulose and/or C5 monomers and/or oligomers are removed prior to the recovery of the C6/lignin mixture.

In one embodiment, the parameters of the pretreatment are changed such that concentration of simple sugars in the pretreated feedstock is 1%, 5%, 10%, 12%, 13%, 14%, 15%, 16%, 17%, 19%, 20%, 30%, 40% or 50%. In one embodiment, the parameters of the pretreatment are changed such that concentration of simple sugars in the pretreated feedstock is 0% to 20%. In one embodiment, the parameters of the pretreatment are changed such that concentration of simple sugars in the pretreated feedstock is 0% to 5%. Examples of simple sugars include, but are not limited to, C5 and C6 monomers and dimers.

In one embodiment, the parameters of the pretreatment are changed such that concentration of lignin in the pretreated and/or hydrolyzed feedstock is 1%, 5%, 10%, 12%, 13%, 14%, 15%, 16%, 17%, 19%, 20%, 30%, 40% or 50% and optimal for fractionation with enzymes.

In one embodiment, the parameters of the pretreatment are changed such that concentration of furfural and low molecular weight lignin in the pretreated and/or hydrolyzed feedstock is less than 10%, 9%, 8%, 7%, 6%, 5%, 4%, 3%, 2%, or 1%. In one embodiment, the parameters of the pretreatment and/or hydrolysis are changed such that concentration of furfural and low molecular weight lignin in the pretreated feedstock is less than 1% to 2%.

In one embodiment, the parameters of the pretreatment are changed to obtain a low concentration of hemicellulose and a high concentration of lignin and cellulose.

In one embodiment, more than one of these steps can occur at any given time. For example, solubilization the pretreated lignin residues and hydrolysis of the oligosaccharides can occur simultaneously, and one or more of these can occur simultaneously to the high conversion of monosaccharides to a fuel or chemical and a higher concentration of lignin residues.

In another embodiment, the enzymes of the method are produced by a biocatalyst, including a range of hydrolytic enzymes suitable for the biomass materials used. In one embodiment, a biocatalyst is grown under conditions appropriate to induce and/or promote production of the enzymes needed for the saccharification of the polysaccharide present. The production of these enzymes can occur in a separate vessel, such as a seed fermentation vessel or other fermentation vessel, or in the production fermentation vessel where ethanol production occurs. When the enzymes are produced in a separate vessel, they can, for example, be transferred to the production fermentation vessel along with the cells, or as a relatively cell free solution liquid containing the intercellular medium with the enzymes. When the enzymes are produced in a separate vessel, they can also be dried and/or purified prior to adding them to the hydrolysis or the production fermentation vessel. The conditions appropriate for production of the enzymes are frequently managed by growing the cells in a medium that includes the biomass that the cells will be expected to hydrolyze in subsequent fermentation steps. Additional medium components, such as salt supplements, growth factors, and cofactors including, but not limited to phytate, amino acids, and peptides can also assist in the production of the enzymes utilized by the microorganism in the production of the desired products.

Biofuel Plant and Process of Producing Biofuel and Biochemicals:

Large Scale Fuel, Chemical, and Microcrystalline Cellulose Production from Biomass

Generally, there are several basic approaches to producing lignin, fuels and chemical end-products from biomass on a large scale. In the one method, one first pretreats and hydrolyzes a biomass material that includes high molecular weight carbohydrates to lower molecular weight carbohydrates and a high concentration of lignin residues, and then ferments the lower molecular weight carbohydrates utilizing of microbial cells to produce fuel or other products. In the second method, one treats the biomass material itself using mechanical, chemical and/or enzymatic methods. In all methods, depending on the type of biomass and its physical manifestation, one of the processes can comprise a milling of the carbonaceous material, via wet or dry milling, to reduce the material in size and increase the surface to volume ratio (physical modification). Further reduction in size can occur during hydrolysis depending on the type of mechanisms used to pretreat the feedstock. For example, use of an extruder with one or more screws to physically hydrolyze the biomass will result in a reduction in particle size as well. See, e.g., the process described in PCT/US2015/064850.

In one embodiment, hydrolysis can be accomplished using acids, e.g., Bronsted acids (e.g., sulfuric or hydrochloric acid), or combination of these. Hydrolysis and/or steam treatment of the biomass can, e.g., increase porosity and/or surface area of the biomass, often leaving the cellulosic and lignin materials more exposed to further treatment, which can increase yield of sugars, cellulose and lignin. Removal of lignin following solubilization can result in a low sulfur, low ash, and high porosity lignin residue for the production of activated carbon and other products. The lignin residues can comprise 50% or more of solid particles. Depending on feedstock composition, the lignin residues will contain at least 50% of solid particles from about 5 microns to about 150 microns in size. More typically, but depending on feedstock composition, lignin residues of a pretreated biomass wherein the lignin residues comprise at least 50% of solid particles from about 5 microns to about 150 microns in size. The remaining materials comprise a surprisingly pure crystalline cellulose, which parameters characterize it as MCC. In one embodiment, the MCC can also contain nanocellulose through variation of the pretreatment conditions.

Biomass Processing Plant and Process of Producing Cellulose and Lignin Products From Biomass

In one aspect, a fuel or chemical plant or system that includes a pretreatment unit to prepare biomass for improved exposure and biopolymer separation, an extruder hydrolysis unit configured to hydrolyze a sugar-containing material that includes a high molecular weight carbohydrate, and one or more product recovery system(s) to isolate a sugar or cellulose product or products and associated by-products and lignin co-products is provided. In another aspect, the pretreatment unit produces a pretreated biomass composition comprising solid particles, C5 and C6 polymers, monomers and dimers by hydrating the biomass composition in a non-neutral pH aqueous medium to produce a hydrated biomass composition that is reduced in size heating the biomass composition under pressure for a time sufficient to produce carbohydrate monomers and oligomers and lignin residues. In another aspect, methods of purifying lower molecular weight carbohydrate from solid byproducts and/or toxic impurities are provided.

In one aspect the biomass processing plant or system includes an enzymatic hydrolysis unit to produce a sugar stream that contains C5 and/or C6 sugars. The enzymatic hydrolysis is preceded by neutralizing the pretreated hydrolysis product by adjusting the pH to a range of pH 4.5 to pH 6.5, preferably about pH 5.5 for optimal cellulolytic and hemicellulolytic hydrolysis. The pH-adjusted hydrolysis product is then enzymatically hydrolyzed by isolated enzymes or other biocatalysts for a period of time to hydrolyze the carbohydrate polymers to monomers. In one embodiment, a biocatalyst includes microorganisms that hydrolyze carbohydrate polymers to oligomers and monomers. Or, alternately, the enzymatic hydrolysis would be applied to the separated MCC to make either a nanocellulose product, or using a full hydrolysis, make very pure C6 sugars.

In another aspect, methods of making a product or products that include combining biocatalyst cells of a microorganism and a biomass feed in a medium wherein the biomass feed contains lower molecular weight carbohydrates and/or other liquids from pretreatment and hydrolysis, and fermenting the biomass material under conditions and for a time sufficient to produce a biofuel, chemical product or fermentive end-products, e.g. ethanol, propanol, hydrogen, succinic acid, lignin, terpenoids, and the like as described above, is provided. The pretreated biomass liquid stream is contacted with the enzyme mix or microorganisms, or both for sufficient time to product a sugar stream or a bioproduct.

In another aspect, a separation unit is provided that comprises a means to separate the cellulose/lignin residues from the sugars, proteins, any products formed, and other materials. Separation can occur by means of filtration, flocculation, centrifugation, and the like.

In another aspect, products made by any of the processes described herein are also provided herein.

This system can be constructed so that all of the units are physically close, if not attached to one and other to reduce the costs of transportation of a product. For example, the pretreatment, enzymatic hydrolysis, separation, MCC recovery unit, and nanocellulose conversion unit can all be located near a woodshed, at a sawmill or agricultural site. Not only is the cost of transporting the biomass to the pretreatment unit virtually eliminated, the sugars, sugar polymers, and solid residues are processed in the units, thus eradicating the cost of shipping the platform products. Thus, in addition to sugars, sugar products, MCC, nanocellulose, fuels, such as ethanol, and other biochemicals, the same processing facility can produce activated carbon and/or other lignin products for many different uses.

### EXAMPLES

The following examples serve to illustrate certain embodiments and aspects and are not to be construed as limiting the scope thereof.

### Example 1

### Pretreatment of Biomass

A twin screw extruder (32 mm unit) was used to perform pretreatment on hardwood sawdust. A flow rate of up to 300 lb/hr was reached through the extruder, with direct steam injection to supply process heat. The feed was metered through a weight belt feeder and fell into a crammer feeder supplying the barrel of the extruder. The biomass was conveyed through the extruder to a high pressure grinding section, where a high pressure plug is formed prior to the material entering the high pressure reaction zone. Within the reaction zone, two screws intermeshed and provided rapid heat and mass transfer when steam and sulfuric acid were injected through steam and acid ports connected to the cylindrical barrel of the extruder. The steam and acid supplying ports were sealed by reverse-flow sections in the screws. A hydraulically operated pressure control valve was seated in a ceramic seal and pressure was controlled to maintain as constant a pressure as possible in the reaction section of the extruder. The combination of acid hydrolysis and mechanical grinding in the reaction zone further reduced the particle size of the biomass.

The solids were exposed to high temperature and pressure and low pH for a maximum of about 10 seconds in the reaction zone of the extruder before being exploded into the flash tank. Residence time in the reaction zone was controlled by the feed rate and the rotational speed of the screws. The surge chamber above the screws in the pump feeder acted as a flash vessel, where hot water is vaporized, cooling the product and removing some of the low-boiling inhibitors, such as furfural. HMF and furfural, reversion inhibitors, were formed in small amounts during this pretreatment (e.g., a total of 0.3 to 0.5 wt. % of the dry pretreated product).

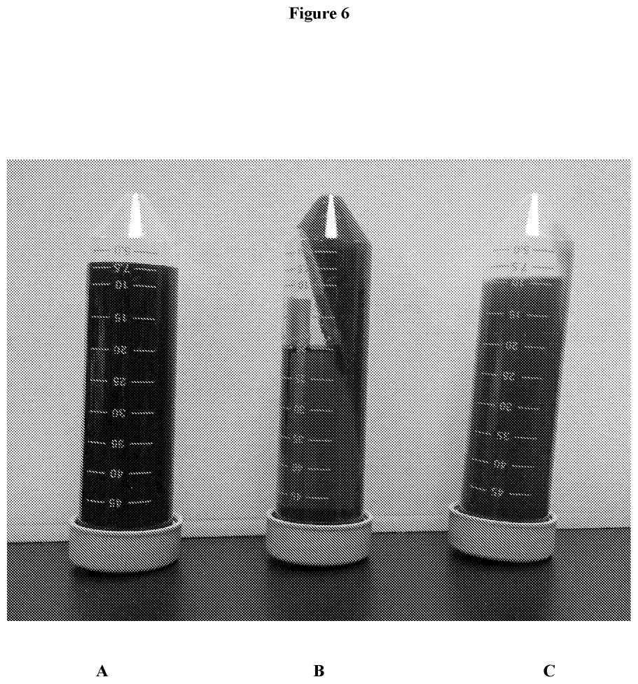

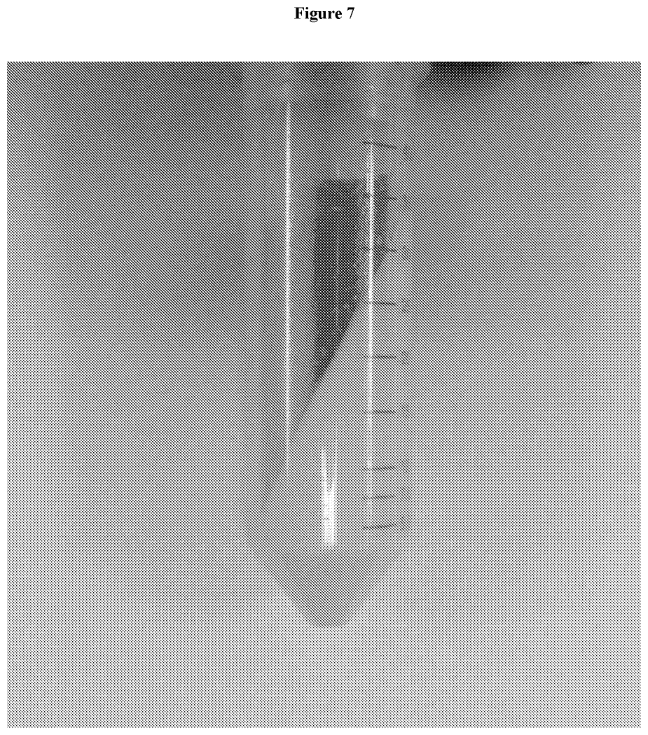

The product was collected, and the C5 rich sugar stream and low levels of soluble byproducts were removed from the solid cellulose and lignin fractions, and was washed with water and the wash water collected. It should be noted that over 90% of the available xylose and 20% of the available glucose was solubilized in the pretreatment step, indicating high conversions of hemicellulose and amorphous cellulose. The remaining solids were resuspended and the pH raised to 11 with NaOH at room temperature and pressure to solubilize the lignin (FIG. 6A) and leave the crystalline cellulose as the main solid fraction. This material was centrifuged in order to collect the solid crystalline cellulose fraction and separate it from the liquid fraction containing the soluble lignin. Following this step, the pH of the liquid stream containing the lignin was adjusted to 7.0 to precipitate the lignin which was then centrifuged (FIG. 6B) and separated from the liquid fraction. The resulting MCC was washed using an alkaline solution and the wash water was pH adjusted to test for residual lignin, and there was little to be found, only some residual cellulose (FIG. 6C). The particle size of the extracted cellulose (FIG. 7) was determined to have a mean size of 30 μm, with only 2% of the particles less than 5 μm. In this range, the material qualifies as MCC. Additional bleaching with H202 rendered the cellulose practically colorless.

The refined MCC derived from the previous steps was then enzymatically treated to further fractionate the crystalline cellulose into a nanocellulose product. The enzymatic pathway is a low energy intensity route to nanocellulose.

MCC Characterization.

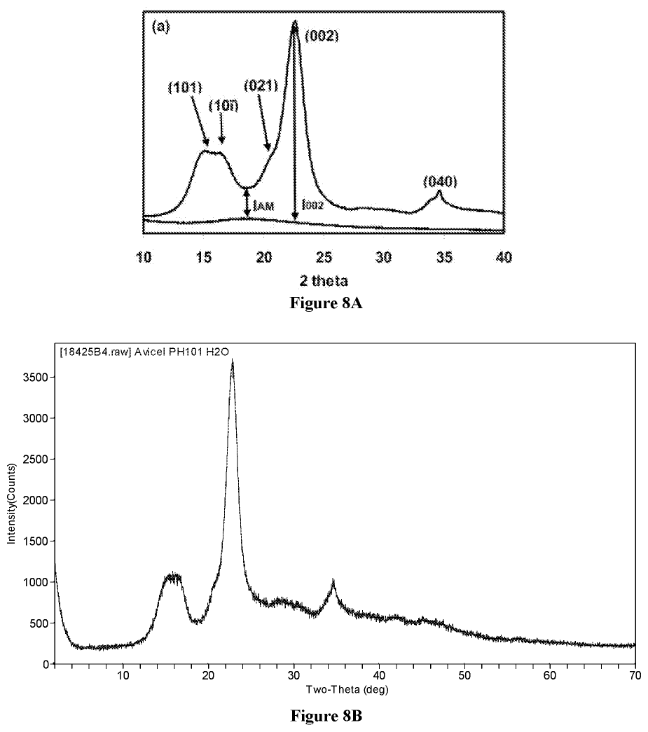

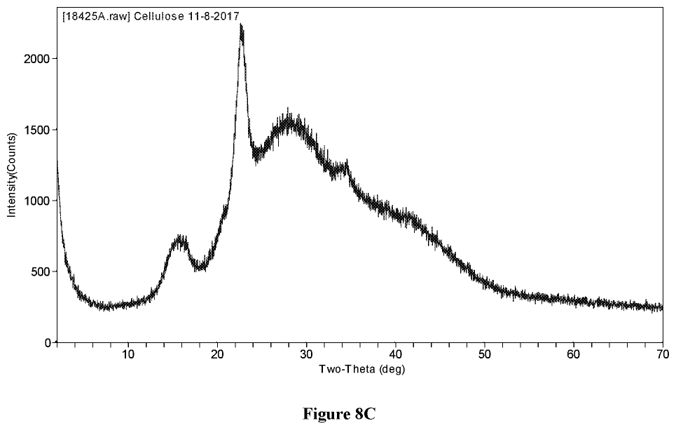

The cellulose produced through the process of this invention shows high crystallinity when compared to an Avicel PH-101 product. Samples were submitted for crystallinity determination using X-ray diffraction (XRD). XRD data were collected using a Rigaku D2000 diffraction system equipped with a copper anode, diffracted beam monochromator tuned to CuKα radiation, and scintillation detector. An aliquot of the sample was mounted on a front pack sample holder for XRD. The % crystallinity was estimated using peak area ratios for (002) peak with broad peak (101, 10-1) at 2θ=−15° assigned to amorphous contribution. Peak assignments used, FIG. 8A, were from FIG. 1 of the reference Park et. al. Biotechnol. Biofuels. (2010). The XRD pattern for the Avicel PH-101 sample is shown in FIG. 8B. The % crystallinity for (002) peak was estimated to be 80%. The XRD pattern for the cellulose sample is shown in FIG. 8C. The % crystallinity for (002) peak was estimated to be ˜85%.

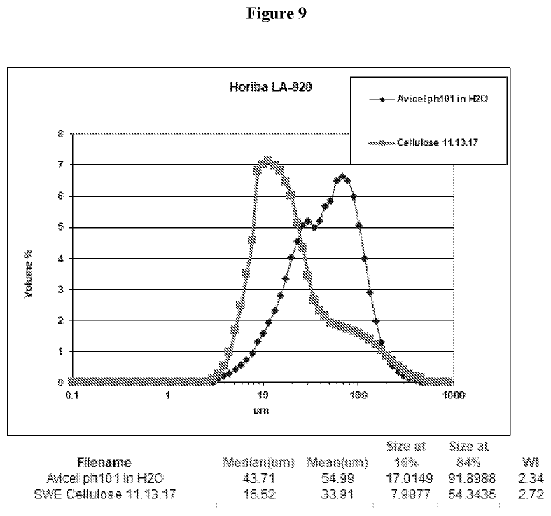

What is termed MCC appears to be a loose agglomeration of cellulose nanofibers. The raw MCC is over 98% cellulose and appears to have a mean particle size of roughly 30 microns when evaluated with optical and light scattering sizing methodologies. A particle sizing comparison of the cellulose material and a sample of Avicel PH-101 based on Horiba LA-920 analysis is shown in FIG. 9.

Results of oscillation stress testing on a 3% MCC suspension show that the storage modulus is higher than the loss modulus and that they are stable over a wide range of stress. This verifies that the MCC is capable of forming a stable gel. Additionally, results of shear recovery testing show a steady increase in viscosity after a short duration of high shear, further validating the gel formation characteristic of an MCC product.

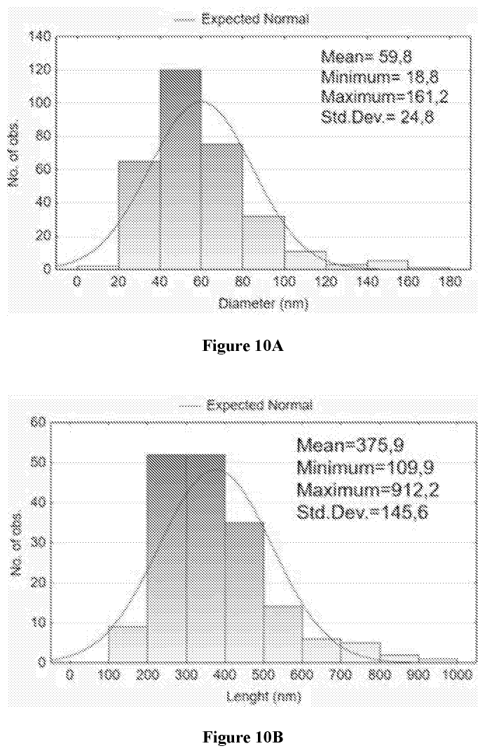

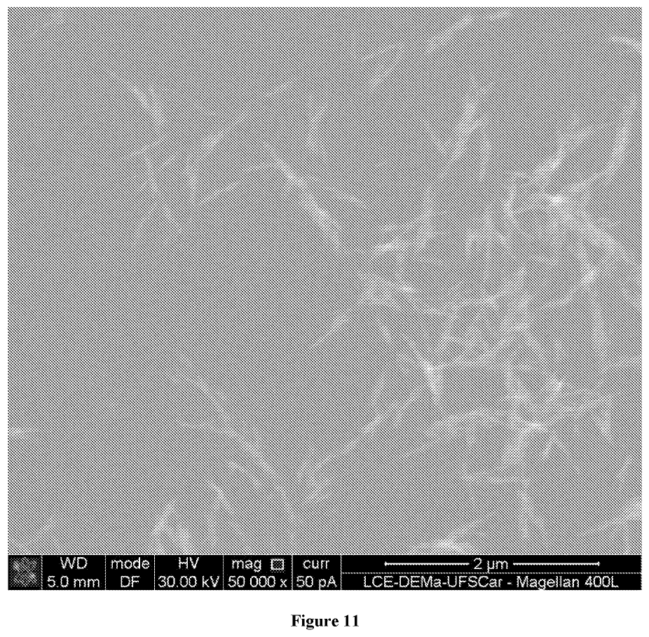

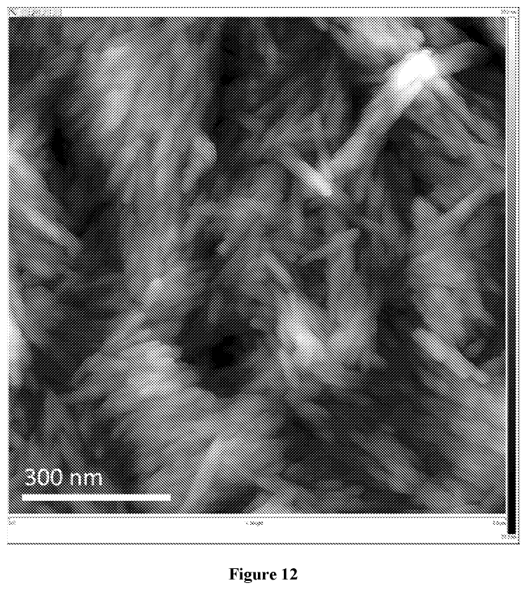

When analyzed with SEM morphology, the MCC is shown to consist of loosely agglomerated particles. Particle size distributions and images are shown in FIGS. 10A, 10B and 11, respectively. Subsequent AFM imaging of the MCC product shows that at its foundation, it is composed of agglomerated cellulose nanocrystals (CNCs) as shown in FIG. 12.

The efficient acid hydrolysis combined with a steam explosion step at the end of the pretreatment process yields a very unique cellulose product. The degree of polymerization of the hybrid MCC is 162, which reinforces the concept that the material consists of agglomerated nanofibrils.

The loose agglomeration of nanofibrils that composes the MCC is very amenable to further low net energy processing. An experiment was conducted wherein the raw MCC material was sonicated for a matter of minutes with the result being a rapid phase change from a white MCC product to a translucent gel that showed thixotropic tendencies that the translucent gel resulting from the brief sonication exhibited characteristics of a nanocellulose suspension. The MCC was benchmarked versus Avicel PH-101. A summary of results is shown in Table 2.

TABLE 2

| | | | | Minutes | | | | | | | | | | | | | | | |
|---|---|---|---|---|---|---|---|---|---|---|---|---|---|---|---|---|---|---|---|
| | | | | T0 | | | T1 | | | T2 | | | T3 | | | T4 | | | Final |
| | Volume | Solids | Power | W | kHz | Wh | W | kHz | Wh | W | kHz | Wh | W | kHz | Wh | W | kHz | Wh | Temp |
| MCC | 150 mL | 2% | 100% | 155 | 26.08 | — | 146 | 26.01 | 2.66 | 140 | 25.97 | 5.1 | 120 | 25.92 | 7.39 | 117 | 25.9 | 9.21 | 68° C. |
| Observations | | | | Started to gel at | | | Continues to get | | | Very chunky at | | | Clear separation | | | Thick, chunky gel-like | | | |
| | | | | 50 sec | | | thicker | | | surface | | | line of solids and | | | material | | | |
| | | | | | | | | | | | | | water along | | | | | | |
| | | | | | | | | | | | | | edge of beaker | | | | | | |
| Avicel PH-101 | 150 mL | 2% | 100% | 153 | 26.02 | — | 149 | 25.99 | 2.77 | 140 | 25.95 | 4.9 | 128 | 25.91 | 7.19 | 124 | 25.87 | 9.3 | 68° C. |

| | | | |
|---|---|---|---|
| Observations | Moving very | Some solid | White, snowflake/flocc- |
| | easily with | separation | like aggregates |
| | sonication | noticeable, no | suspended in water. |
| | | viable viscosity | Starts to settle |
| | | change | |

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A low-energy intensive method for producing cellulose from biomass, the method comprising:
a. pretreating said biomass with fibrillation, an acid, an elevated temperature, and an elevated pressure within an extruder to produce a liquid fraction comprising solubilized hemicellulose and/amorphous cellulose and a solids fraction comprising cellulose and lignin;
b. separating the liquid fraction from the solids fraction;
c. treating the solids fraction with an alkaline solution to solubilize the lignin, thereby producing solubilized lignin; and
d. separating the solubilized lignin from the cellulose.

2. The method of claim 1, wherein the cellulose comprises crystalline cellulose and nanocellulose.

3. The method of claim 1, wherein the particle size of the cellulose has a particle size between 2 μm and 120 μm.

4. The method of claim 1, wherein the cellulose has a mean particle size about 60 μm.

5. The method of claim 1, wherein the lignin is solubilized by ionic liquid.

6. (canceled)

7. The method of claim 1 wherein by treating the solids fraction with the alkaline solution, pH of the solids fraction is raised to about 7.5, about 8.0, about 8.5, about 9.0, about 9.5, about 10.0, about 10.5, or about 11.

8. (canceled)

9. The method of claim 1 wherein the alkaline solution comprises a compound selected from the group consisting of: sodium hydroxide, calcium hydroxide, potassium hydroxide, ammonia, ammonia hydroxide, hydrogen peroxide, and a combination thereof.

10. (canceled)

11. The method of claim 1, wherein the alkaline solution comprises a ionic liquid selected from the group consisting of: ethanol, ammonium, phosphonium and pyrrolidinium-based ionic liquids, and a combination thereof.

12. The method of claim 1, wherein the lignin is separated from the cellulose by centrifugation, filtration, membrane filtration, diafiltration, or flocculation.

13. The method of claim 1, wherein the lignin is precipitated with acid.

14. The method of claim 13, wherein the acid is selected from the group consisting of: sulfuric acid, peroxyacetic acid, hydrochloric acid, phosphoric acid, oxalic acid, lactic acid, formic acid, acetic acid, citric acid, benzoic acid, sulfurous acid, chloroacetic acid, dichloroacetic acid, trichloroacetic acid, and a combination thereof.

15. The method of claim 1, further comprising converting the lignin into activated carbon, foams, films or other bioproducts.

16. The method of claim 1, further comprising fractionating or hydrolyzing the liquid fraction with enzymes or a biocatalyst.

17. The method of claim 1, further comprising hydrolyzing the liquid fraction by enzymes or a biocatalyst.

18. The method of claim 1, further comprising purifying or clarifying the liquid fraction.

19. The method of claim 1, further comprising converting the liquid fraction into a fuel.

20. The method of claim 1, further comprising hydrolyzing the amorphous cellulose in the presence of sulfuric acid.

21. (canceled)

22. (canceled)

23. The method of claim 1, further comprising decolorizing the cellulose with a decolorizing agent.

24. The method of claim 23, wherein the decolorizing agent is H202.

25. The method of claim 1, wherein the biomass is selected from the group consisting of:
corn syrup, molasses, silage, agricultural residues, corn stover, bagasse, sorghum, nuts, nut shells, coconut shells, Distillers Dried Solubles (DDS), Distillers Dried Grains (DDG), Condensed Distillers Solubles (CDS), Distillers Wet Grains (DWG), Distillers Dried Grains with Solubles (DDGS), woody materials, sawdust, wood chips, timber slash, mill scrap, municipal waste, waste paper, recycled toilet papers, yard clippings, and energy crops such as poplars, willows, switchgrass, alfalfa, and prairie bluestem, algae, including Chlorophyta, Phaeophyta, and Rhodophyta, non-woody plant matter, cellulosic material, lignocellulosic material, hemicellulosic material, carbohydrates, pectin, starch, inulin, fructans, glucans, corn, sugar cane, grasses, switchgrass, high biomass sorghum, bamboo, corncobs, peels, and pits.

26-29. (canceled)
